(19) United States
(12) Patent Application Publication
(10) Pub. No.: US 2011/0029937 A1
(43) Pub. Date: Feb. 3, 2011

(54) PATTERN EVALUATING METHOD, PATTERN GENERATING METHOD, AND COMPUTER PROGRAM PRODUCT

(76) Inventors: Katsuyoshi KODERA, Kanagawa (JP); Satoshi TANAKA, Kanagawa (JP); Toshiya KOTANI, Tokyo (JP); Shigeki NOJIMA, Kanagawa (JP); Soichi INOUE, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/836,235

(22) Filed: Jul. 14, 2010

(30) Foreign Application Priority Data
Jul. 28, 2009 (JP) 2009-175433

(51) Int. Cl. G06F 17/50

(52) U.S. Cl. 716/52

(57) ABSTRACT

A pattern evaluating method includes generating a proximity pattern that affects a resolution performance of a circuit pattern around a lithography target pattern of the circuit pattern to be formed on the substrate, generating distribution information on a distribution of an influence degree to the resolution performance of the circuit pattern by using the lithography target pattern, calculating the influence degree to the resolution performance of the circuit pattern by the proximity pattern as a score by comparing the distribution information with the proximity pattern, and evaluating whether the proximity pattern is placed at an appropriate position in accordance with the circuit pattern based on the score.

### CROSS-REFERENCE TO RELATED APPLICATIONS

This application is based upon and claims the benefit of priority from the prior Japanese Patent Application No. 2009-175433, filed on Jul. 28, 2009; the entire contents of which are incorporated herein by reference.

### FIELD

Embodiments described herein relate generally to a pattern evaluating method, a pattern generating method, and a computer program product.

### BACKGROUND

In recent years, with the miniaturization of a pattern constituting a semiconductor device, it has become difficult to ensure a sufficient process margin only by fine adjustment of a main pattern. Therefore, recently, a layout design using an assist pattern (SRAF: Sub-Resolution Assist Feature) is used. The SRAF needs to be placed to sufficiently ensure a plurality of process latitudes. For example, the SRAF needs to be placed to ensure each latitude with respect to an EL (Exposure Latitude), a DOF (Depth of Focus), an MEF (Mask Enhancement Factor), and a σ (coherent factor) sensitivity of a light source.

A placing method of such SRAF includes two placing methods of a rule-based SRAF placing method and a model-based SRAF placing method. The rule-based SRAF placing method is a method of generating an optimum SRAF placement rule for each design layout manually by a lithography design engineer based on a budget of required various process margins. A degree of optimization of the SRAF in the case of using this rule-based SRAF placing method is high; however, there are two demerits that a long TAT is required for generating this rule and generation of the SRAF placement rule with respect to a random layout is difficult.

On the other hand, the model-based SRAF placing method is a method in which an approximation allowable in view of accuracy is performed on an exposure apparatus optical system to calculate an optimum SRAF placement that improves a certain single process latitude only from an approximated optical model (for example, see U.S. Patent No. 2004/0229133 A1). A plurality of physics models can be considered as the optical model, such as an SRAF placement calculation model that maximizes the EL and an SRAF placement calculation model that maximizes the DOF. This model-based SRAF placing method has merits that the TAT for generating the SRAF placement rule does not become long different from the rule-based SRAF placing method and the optimum SRAF placement can be calculated even with respect to a layout with high randomness.

Conventionally, a lithography designer performs generation of the SRAF placement rule or generation of the SRAF placement model so that a sufficient process margin can be ensured with respect to a representative mask layout. Thereafter, the SRAF is generated in the actual design data including a random layout based on the generated SRAF placement rule or SRAF placement model, and then an optical proximity correction (OPC) is performed in a state where the SRAF is placed to generate mask layout data. Subsequently, a lithography verification of the generated mask layout data is performed and validity of the mask layout data is determined (for example, see Japanese Patent Application Laid-open No. 2004-157475).

However, when the lithography verification of the mask layout data is performed after performing the OPC process, the following problem arises. That is, as a result of determining the validity of the mask layout data by the lithography verification, it is found for the first time that the process margin is insufficient with respect to the mask layout data that was not initially assumed. In this case, it is needed to return to revision of the SRAF placement rule or the SRAF placement model. If such a returning process is needed, a problem arises in that it takes about one month to generate new mask layout data in some cases.

### BRIEF DESCRIPTION OF THE DRAWINGS

FIG. 1 is a block diagram illustrating a configuration of a pattern evaluating apparatus according to a first embodiment;

FIG. 2 is a flowchart illustrating a process procedure of a mask pattern data generation according to the first embodiment;

FIG. 3 is a flowchart illustrating a determining process procedure of an SRAF;

FIG. 4A to FIG. 4C are diagrams for explaining a configuration example of an interference map;

FIG. 5A and FIG. 5B are diagrams for explaining the SRAF whose score is high and the SRAF whose score is low;

FIG. 6 is a block diagram illustrating a configuration of a pattern changing apparatus;

FIG. 7 is a diagram illustrating a configuration of a pattern generating apparatus according to a second embodiment;

FIG. 8 is a flowchart illustrating a generating process procedure of the SRAF;

FIG. 9A and FIG. 9B are diagrams illustrating a result of predicting an optimum SRAF placement position based on a plurality of types of physics models with respect to the same lithography target;

FIG. 10 is a flowchart illustrating a mask-pattern-data generating process procedure according to a third embodiment;

FIG. 11A to FIG. 11E are diagrams illustrating the interference maps of an isolated hole layout pattern;

FIG. 12 is a flowchart illustrating a determining process procedure of an SRAF minimum dimension;

FIG. 13 is a diagram for explaining a correspondence relationship between a process latitude and a mask manufacturing cost; and

FIG. 14 is a diagram illustrating a hardware configuration of the pattern evaluating apparatus.

### DETAILED DESCRIPTION

In general, according to one embodiment, a pattern evaluating method, includes generating a proximity pattern that affects a resolution performance of a circuit pattern when forming the circuit pattern on a substrate, around a lithography target pattern that is set based on design data corresponding to the circuit pattern to be formed on the substrate. Moreover, the method generates distribution information on a distribution of an influence degree to the resolution performance of the circuit pattern when a predetermined proximity pattern is placed around the lithography target pattern by using the lithography target pattern. Furthermore, the method calculates the influence degree to the resolution performance of the circuit pattern by the proximity pattern as a score by comparing the distribution information with the proximity pattern. Moreover, the method evaluates whether the proximity pattern is placed at an appropriate position in accordance with the circuit pattern based on the score.

Exemplary embodiments of the pattern evaluating method, a pattern generating method, and a computer program product. will be explained below in detail with reference to the accompanying drawings. The present invention is not limited to the following embodiments.

### First Embodiment

In the present embodiment, a placement position of an SRAF (assist pattern that is not resolved) generated on a mask pattern used in a lithography process of a semiconductor device is evaluated. Then, when the placement position of the SRAF is inappropriate, the placement position of the SRAF, an SRAF placement rule, an SRAF placement model, or the like is changed, and thereafter an OPC (Optical Proximity Correction) is performed. One of the characteristics of the present embodiment is an evaluating method of the placement position of the SRAF.

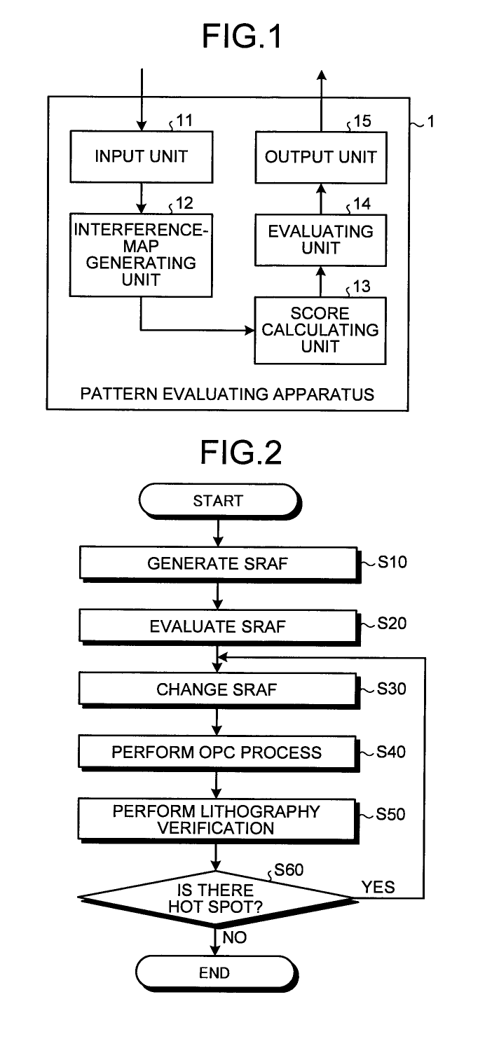

FIG. 1 is a block diagram illustrating a configuration of a pattern evaluating apparatus according to the first embodiment. A pattern evaluating apparatus 1 is an apparatus, such as a computer, that evaluates the mask pattern used in the lithography process of a semiconductor device and extracts a hot spot (danger point that is highly likely to be a pattern formation failure) from the mask pattern.

The pattern evaluating apparatus 1 determines and extracts the SRAF whose placement position is inappropriate or a type of a process in which a process margin becomes smaller than a predetermined value before the OPC process by using the mask pattern in which the SRAF is placed. In the present embodiment, the case is explained in which the pattern evaluating apparatus 1 extracts the SRAF whose placement position is inappropriate by using the mask pattern before the OPC process that is generated by placing the SRAF.

The mask pattern before the OPC process includes a product mask pattern (lithography target LT1 to be described later) corresponding to a product pattern (actual pattern to be a product target pattern) formed on a substrate such as a wafer, and the SRAF. The product mask pattern is a pattern on the mask pattern of the product pattern, and the SRAF is a proximity pattern that affects a shape of the product pattern when the product pattern is formed on the wafer.

The pattern evaluating apparatus 1 includes an input unit 11, an interference-map generating unit 12, a score calculating unit 13, an evaluating unit 14, and an output unit 15. The input unit 11 inputs the lithography target LT1 generated by using design data and mask pattern data before the OPC process in which a candidate SRAF is placed. The lithography target LT1 is a target pattern that is obtained by performing a target MDP process on the design data. The mask pattern data input to the input unit 11 can be the mask pattern data generated by a rule-based SRAF placing method or the mask pattern data generated by a model-based SRAF placing method.

The interference-map generating unit 12 generates an interference map on the lithography target LT1 by using the lithography target LT1 input to the input unit 11. The interference map is a coherent map that represents coherency of a projection optical system and represents a distribution (distribution information) of an influence degree to a resolution performance of the product mask pattern. The influence degree to the resolution performance includes a process latitude (process margin). The interference map is information indicating a distribution of appropriateness (optimum degree) of the placement position of the SRAF and is divided into regions in accordance with the appropriateness. For example, when the SRAF is placed, the interference map includes a mask region (appropriate region) (regions A5 and A4 to be described later) in which a pattern having the same shape as the product pattern can be formed robustly with respect to a process fluctuation, a mask region (inappropriate region) (regions A1 and A2 to be described later) in which only a pattern having a shape significantly different from the product pattern can be formed, and a mask region (region A3 to be described later) that has the appropriateness between the appropriate region and the inappropriate region. The interference-map generating unit 12 sends the generated interference map to the score calculating unit 13.

The score calculating unit 13 calculates the appropriateness of the placement position of the SRAF as a quantitative value (score) for the SRAF in the mask pattern by using the interference map generated by the interference-map generating unit 12. The appropriateness of the placement position of the SRAF corresponds to the degree to which the product pattern having a desired shape is formed when the lithography target LT1 of the product pattern is formed on the wafer. Specifically, when the product pattern whose shape is close to the desired shape can be formed on a wafer, the score of the SRAF becomes high, and when the product pattern whose shape is different from the desired shape is formed on a wafer, the score of the SRAF becomes low. The score calculating unit 13 can calculate the score of the SRAF for each SRAF or can calculate the score for a group including a predetermined number of the SRAFs (pattern region including a plurality of the SRAFs). The score calculating unit 13 sends the calculated score of the SRAF to the evaluating unit 14.

The evaluating unit 14 evaluates whether the SRAF in the mask pattern is placed at an appropriate position by using the score of the SRAF calculated by the score calculating unit 13. The evaluating unit 14 extracts the SRAF that is not placed at an appropriate position as a layout that causes the hot spot. The evaluating unit 14 sends an evaluation result of the placement position of the SRAF and the layout extracted as the hot spot to the output unit 15. The output unit 15 outputs the evaluation result of the SRAF by the evaluating unit 14 and the layout to be the hot spot.

Next, a process procedure of the mask pattern data generation is explained. FIG. 2 is a flowchart illustrating the process procedure of the mask pattern data generation according to the first embodiment. A generating apparatus (not shown) of the mask pattern generates the lithography target LT1 that is the product mask pattern by using the design data (design layout data). This lithography data LT1 is a pattern to be the product pattern when being transferred onto a wafer.

After the lithography target LT1 is generated, the generating apparatus of the mask pattern generates and places the SRAF near the lithography target LT1 and the like (Step S10). The generating apparatus of the mask pattern, for example, enlarges a representative process margin, generates the SRAF by the rule-based SRAF placing method or the like, and places the SRAF. At this time, the generating apparatus of the mask pattern places the SRAF by using an SRAF placement rule, an MRC (mask rule compliance check), the interference map corresponding to the lithography target LT1, or the like.

The pattern evaluating apparatus 1 evaluates the mask pattern (hereinafter, SRAF post-placement layout) before the OPC process in which a candidate SRAF is placed. Specifically, the pattern evaluating apparatus 1 evaluates the SRAF based on whether the placement position of the SRAF placed on the mask pattern is appropriate (Step S20).

When the placement position of the SRAF placed on the mask pattern is inappropriate, the SRAF is changed by a changing apparatus (pattern changing apparatus 3 to be described later) of the SRAF (Step S30). The pattern changing apparatus 3 changes the placement position of the SRAF, the SRAF placement rule (pattern placement rule), or the SRAF placement model (pattern placement model) as a changing process of the SRAF.

Thereafter, an OPC processing apparatus (not shown) that performs an OPC process performs the OPC process on the SRAF post-placement layout whose SRAF is changed (Step S40). Then, a lithography verifying apparatus (not shown) that performs a lithography verification performs the lithography verification by using the mask pattern data after the OPC process (Step S50). Then, the lithography verifying apparatus determines whether there is the hot spot in the mask pattern after the OPC process (Step S60). When there is the hot spot in the mask pattern after the OPC process (Yes at Step S60), the changing apparatus of the SRAF changes the SRAF (Step S30).

Then, the OPC processing apparatus performs the OPC process on the mask pattern whose SRAF is changed (Step S40), and the lithography verifying apparatus performs the lithography verification by using the mask pattern data after the OPC process (Step S50). Then, the lithography verifying apparatus determines whether there is the hot spot in the mask pattern after the OPC process (Step S60). Thereafter, the processes at Steps S30 to S60 are repeated until it is determined that there is no hot spot in the mask pattern after the OPC process. Then, when it is determined that there is no hot spot in the mask pattern after the OPC process (No at Step S60), the mask pattern that is determined to have no hot spot is set as the mask pattern to form the product pattern.

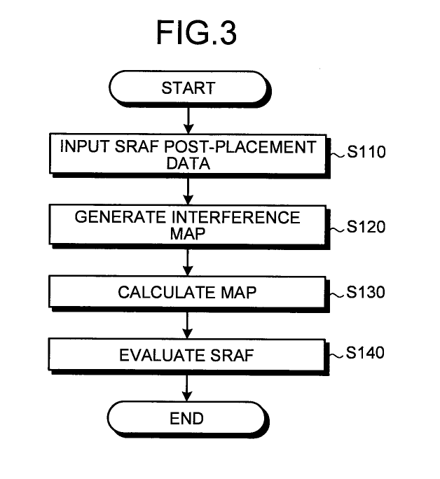

Next, explanation is given for a determining process of the SRAF that is one of the characteristics of the present embodiment. FIG. 3 is a flowchart illustrating the determining process procedure of the SRAF. The lithography target LT1 and the SRAF post-placement layout are input to the input unit 11 of the pattern evaluating apparatus 1 (Step S110).

Conventionally, the interference map is used when generating the SRAF. At this time, the SRAF is generated while setting a predetermined process margin. In the present embodiment also, in the SRAF post-placement layout input to the input unit 11, the SRAF generated by enlarging a representative process margin (such as the EL) is placed.

The interference-map generating unit 12 generates the interference map on the SRAF post-placement layout by using the lithography target LT1 input to the input unit 11 (Step S120). The interference-map generating unit 12 sends the generated interference map to the score calculating unit 13.

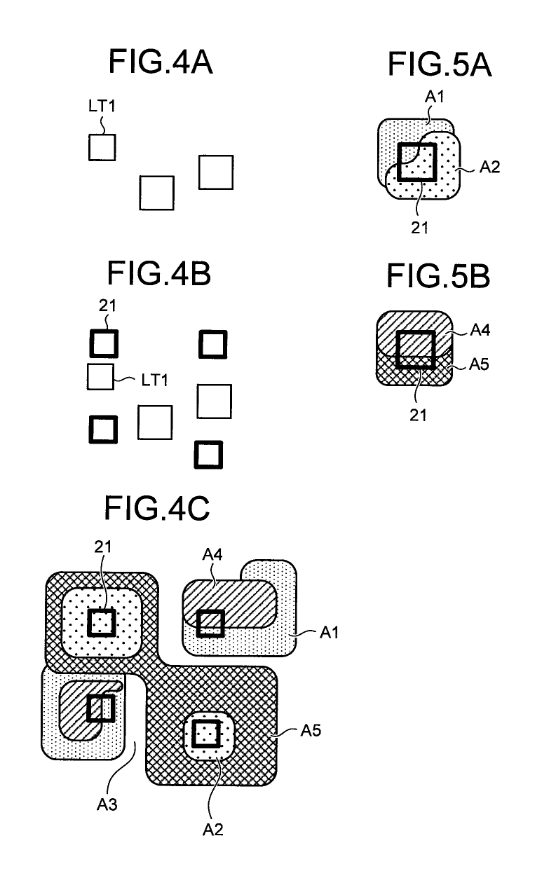

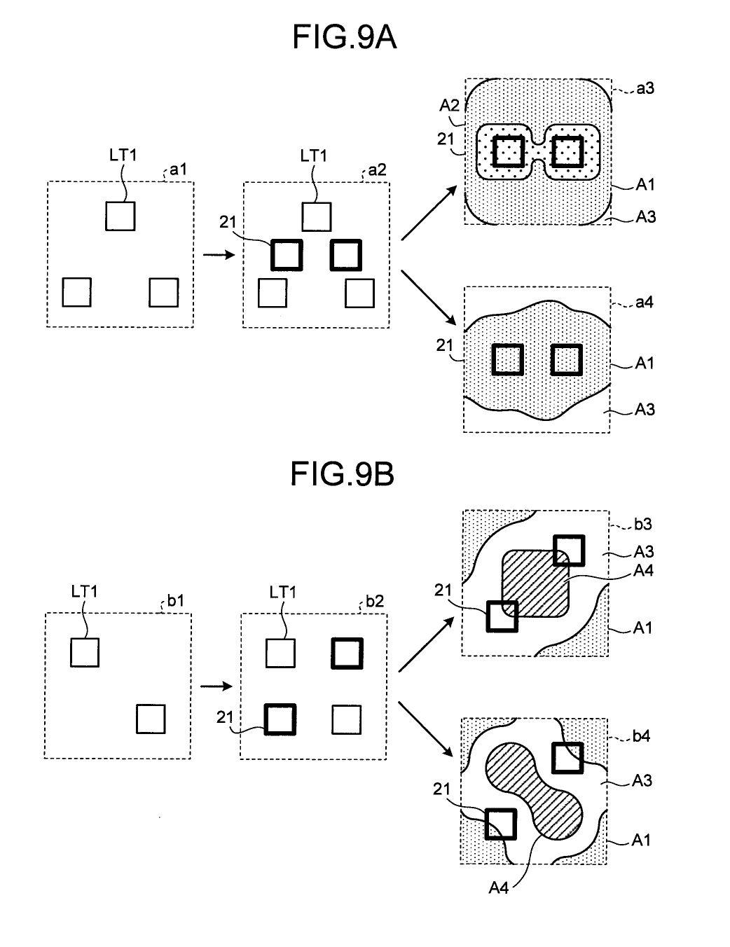

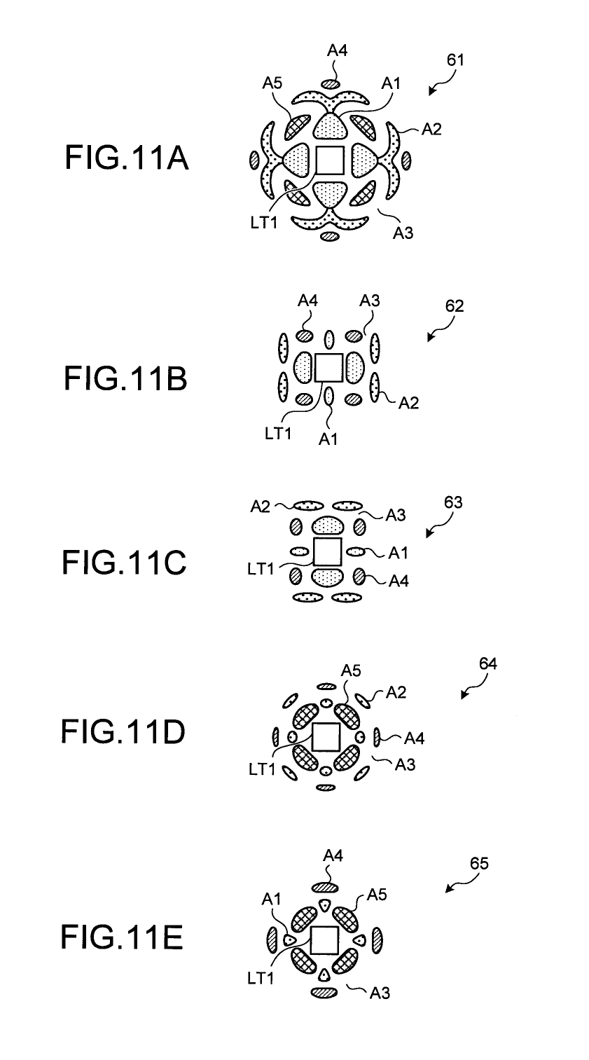

A configuration example of the interference map is explained. FIG. 4A to FIG. 4C are diagrams for explaining the configuration example of the interference map. In FIG. 4A to FIG. 4C, part of the interference map is conceptually illustrated. Hatching is shown in FIG. 4C that illustrates part of the interference map as a top view. In the similar manner to FIG. 4C, hatching is shown in FIG. 5A, FIG. 5B, FIG. 9A, FIG. 9B, and FIG. 11A to FIG. 11E to be described later that each represents a top view.

As shown in FIG. 4A, the lithography targets LT1 as components of the product mask pattern are generated by using the design data. Then, as shown in FIG. 4B, SRAFs 21 are placed near the lithography targets LT1 and the like.

As shown in FIG. 4C, the interference-map generating unit 12 generates the interference map on a pattern of the SRAF post-placement layout in which the lithography targets LT1 and the SRAFs 21 are placed. At this time, the interference-map generating unit 12 generates the interference map by using a predetermined SRAF placement model. As the SRAF placement model, for example, an optimum model (process optimum model) that enlarges any process margin is used. Specifically, the SRAF placement model (SRAF generation model) in which any of the process margins of an EL, a DOF, an MEF, a σ (coherent factor) sensitivity of a light source, and the like is enlarged is used. The SRAF placement model (EL maximizing model) in which the EL is enlarged is a model that is resistant to a dose fluctuation, and the SRAF placement model (DOF maximizing model) in which the DOF is enlarged is a model that is resistant to a defocus fluctuation. Moreover, the SRAF placement model in which the MEF is enlarged is a model that is resistant to a CD fluctuation (dimension fluctuation amount) of a mask, and the model (a sensitivity maximizing model) in which the a sensitivity of a light source is enlarged is a model that is resistant to a light source coherence a fluctuation.

The interference map shown in FIG. 4C is divided into regions A1, A2, A3, A4, and A5 in accordance with the appropriateness (hereinafter, placement appropriateness) of the placement position of the SRAF 21. The lithography target LT1 is not shown in FIG. 4C.

In the interference map, the region A1 is the least appropriate region to place the SRAF 21, and the region A2 is a slightly inappropriate region to place the SRAF 21. The region A5 is the most appropriate region to place the SRAF 21, and the region A4 is a slightly appropriate region to place the SRAF 21. The region A3 is an intermediate region between appropriate and inappropriate as the placement position of the SRAF 21. In other words, the placement appropriateness is high in the order of the regions A5, A4, A3, A2, and A1. In FIG. 4C, the placement appropriateness is represented by five levels of the regions A5, A4, A3, A2, and A1; however, the placement appropriateness can be represented by four or less levels or six or more levels.

The score calculating unit 13 calculates the placement appropriateness of the SRAF 21 in the SRAF post-placement layout as the score by using the interference map generated by the interference-map generating unit 12 (Step S130). The score is calculated by integrating a distribution (distribution expressing a contribution to improvement of an index that constitutes a resolution performance) indicating the placement appropriateness in each region of a mask layout element. Specifically, the score is calculated, for example, by Equation (1). In Equation (1), (x,y) is a region of (x,y)εSRAF 21, and ψ(x,y) is the interference map.

Score=∫∫dxdyψ(x,y) (1)

It is applicable that the score is a value that is maximum or minimum in each region of the mask layout element among values of the placement appropriateness. In other words, the value of the placement appropriateness that is maximum or minimum in the SRAF 21 can be the score. Alternatively, the score can be calculated by using an area of a region that takes a value equal to or more than a threshold or a value equal to or less than the threshold among the placement appropriateness included in each region of the mask layout element. For example, the area of the region that takes a value equal to or more than the threshold or a value equal to or less than the threshold can be used as the score, or the score can be calculated by integrating the distribution indicating the placement appropriateness in the area of the region that takes a value equal to or more than the threshold or a value equal to or less than the threshold.

In the SRAF 21, when the area A5 whose placement appropriateness is high is large, the score becomes high, and when the area A1 whose placement appropriateness is low is large, the score becomes low. In the SRAF 21 whose score is low, any of the SRAF placement rule/SRAF placement model, and the placement position of the SRAF 21 is not appropriate with a high possibility. Therefore, the appropriateness of the SRAF placement rule/SRAF placement model, and the placement position of the SRAF 21 can be determined based on the score of the SRAF 21.

The score calculating unit 13 sends the calculated score of the SRAF 21 to the evaluating unit 14. The evaluating unit 14 evaluates whether the SRAF 21 in the mask pattern is placed at an appropriate position by using the score of the SRAF 21 calculated by the score calculating unit 13 (Step S140). Specifically, the evaluating unit 14 extracts the SRAF 21 (SRAF 21 whose score is lower than a predetermined value) that is not placed at an appropriate position as a layout that causes the hot spot. In this manner, in the present embodiment, it is determined whether the placement position of the SRAF 21 is appropriate by using the interference map.

FIG. 5A and FIG. 5B are diagrams for explaining the SRAF whose score is high and the SRAF whose score is low. The SRAF 21 shown in FIG. 5A is placed in the regions A1 and A2 whose placement appropriateness is low. On the other hand, the SRAF 21 shown in FIG. 5B is placed in the regions A4 and A5 whose placement appropriateness is high. Therefore, the SRAF 21 shown in FIG. 5A has a low score, and the SRAF 21 shown in FIG. 5B has a high score. The mask layout that is not optimum for the SRAF placement can be extracted by the evaluating unit 14 extracting the SRAF 21 (SRAF 21 whose score is low) whose placement position is inappropriate.

Next, explanation is given for a changing process of the SRAF 21 when the SRAF 21 in the mask pattern is not placed at an appropriate position. The changing process of the SRAF 21 is performed by the pattern changing apparatus 3 to be described later.

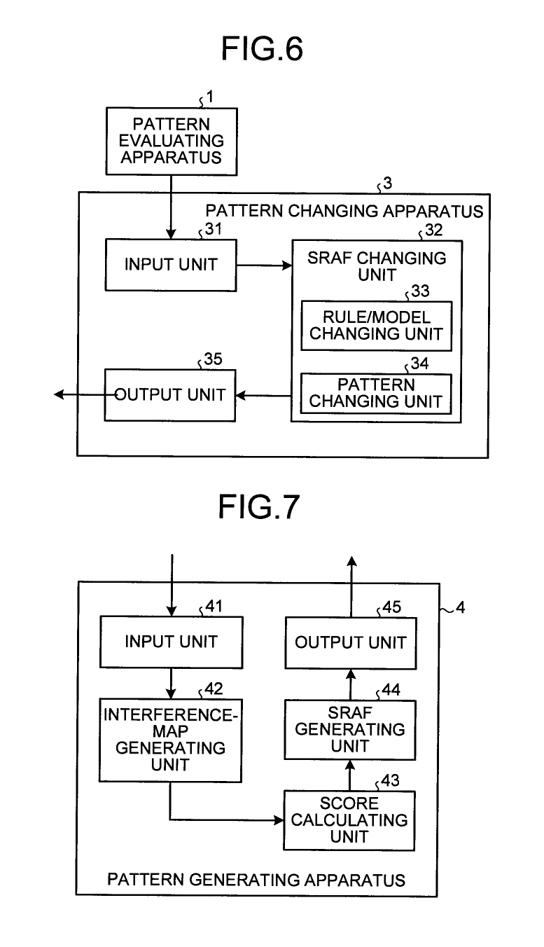

FIG. 6 is a block diagram illustrating a configuration of the pattern changing apparatus. The pattern changing apparatus (SRAF changing apparatus) 3 is an apparatus, such as a computer, that changes the placement position of the SRAF 21, the SRAF placement rule, or the like when the placement position of the SRAF 21 is determined as NG by the pattern evaluating apparatus 1. The pattern changing apparatus 3 includes an input unit 31, an SRAF changing unit 32, and an output unit 35. The SRAF changing unit 32 includes a rule/model changing unit 33 and a pattern changing unit 34.

The input unit 31 inputs the SRAF post-placement layout and the SRAF placement rule/SRAF placement model. The SRAF post-placement layout input to the input unit 31 can be the SRAF post-placement layout generated by the rule-based SRAF placing method or the SRAF post-placement layout generated by the model-based SRAF placing method.

The rule/model changing unit 33 changes the SRAF placement rule/SRAF placement model input to the input unit 31. The pattern changing unit 34 changes the placement position of the SRAF 21 of the SRAF post-placement layout input to the input unit 31. The output unit 35 outputs the SRAF placement rule/SRAF placement model changed by the rule/model changing unit 33 and the SRAF post-placement layout changed by the pattern changing unit 34.

When the SRAF 21 in the SRAF post-placement layout is not placed at an appropriate position, the pattern changing apparatus 3 performs the changing process of the SRAF 21. For example, when the SRAF placement rule is changed as the changing process of the SRAF 21, the SRAF placement rule is input to the input unit 31. This SRAF placement rule is changed by the rule/model changing unit 33 and is output from the output unit 35. The rule/model changing unit 33, for example, changes the SRAF placement rule so that the score of the SRAF 21 on the interference map becomes high.

When the SRAF placement model is changed as the changing process of the SRAF 21, the SRAF placement model is input to the input unit 31. This SRAF placement model is changed by the rule/model changing unit 33 and is output from the output unit 35. The rule/model changing unit 33, for example, changes the SRAF placement model so that the score of the SRAF 21 on the interference map becomes high.

When the placement position of the SRAF 21 is changed as the changing process of the SRAF 21, the SRAF post-placement layout is input to the input unit 31. The placement position of the SRAF 21 of the SRAF post-placement layout is changed by the pattern changing unit 34 to be output from the output unit 35. The pattern changing unit 34, for example, moves the placement position of the SRAF 21 to a region with high placement appropriateness, such as the regions A4 and A5, so that the score of the SRAF 21 on the interference map becomes high.

Explanation is given for a difference between a conventional SRAF evaluating method and the SRAF evaluating method in the present embodiment. Typically, the SRAF that affects the shape of the product pattern is different depending on a layout, and specially, the best SRAF placement model is hard to generate with the design data (lithography target) including many random layouts, which is a problem. Therefore, conventionally, after a lithography designer generates the SRAF placement model, it is needed to actually place the SRAF based on the SRAF placement model, and determine whether it is possible to form the product pattern of a desired shape with respect to the design data, to which the SRAF placement rule/SRAF placement model is applied, by the lithography verification after the OPC process. In this lithography verification, when the shape of the product pattern is determined as NG, the SRAF placement rule/SRAF placement model needs to be reviewed, so that the TAT delays for one month in some cases.

A generating process of the SRAF is often realized by a rule base or a convolution operation of the design data and an integral kernel function (coherent map method), and the TAT thereof is extremely short compared with the OPC process or the lithography verification. In the present embodiment, evaluation of the SRAF 21 is performed and the SRAF 21 is changed if needed, and thereafter the OPC process and the lithography verification are performed, so that it is possible to reduce the number of times of repeating the lithography verification, and consequently the mask pattern can be completed in a short TAT.

In the present embodiment, explanation is given for the case where the mask pattern (proximity pattern) that affects a shape of a formation pattern is the SRAF 21 when the pattern (formation pattern) corresponding to the evaluation target pattern (lithography target LT1) is formed on a wafer; however, the proximity pattern can be a pattern other than the SRAF 21. For example, the proximity pattern can be a serif pattern, a hammerhead pattern, or a lithography target corresponding to the formation pattern (actual pattern) that is actually formed.

The SRAF post-placement layout that is determined as NG by the pattern evaluating apparatus 1 and is changed by the pattern changing apparatus 3 is subjected to the lithography verification after the OPC process. The SRAF post-placement layout that is determined to pass by the pattern evaluating apparatus 1 is used for manufacturing a photomask. In other words, the photomask is manufactured based on the SRAF post-placement layout that is determined to pass by the pattern evaluating apparatus 1. The SRAF post-placement layout is, for example, evaluated for each layer of a wafer process. When the SRAF post-placement layout is determined in each exposure process, the photomask for each layer is manufactured by using the determined SRAF post-placement layout.

Then, a semiconductor device (semiconductor integrated circuit), is manufactured by using the photomask in the wafer process. Specifically, an exposure apparatus performs the exposure process on a wafer, which is thereafter subjected to a development process, an etching process, and the like of the wafer. Specifically, a mask material is processed with a resist pattern formed by transfer in the lithography process and further a process target film is etched to be patterned by using the patterned mask material. When manufacturing a semiconductor device, the above described SRAF evaluation, SRAF changing, exposure process, development process, and etching process are repeated for each layer.

In the present embodiment, evaluation of the SRAF 21 is performed before the OPC process; however, the evaluation of the SRAF 21 can be performed after the OPC process. Moreover, in the present embodiment, the case is explained in which the pattern changing apparatus 3 includes both of the rule/model changing unit 33 and the pattern changing unit 34; however, it is sufficient that the pattern changing apparatus 3 includes any one of the rule/model changing unit 33 and the pattern changing unit 34.

Furthermore, in the present embodiment, explanation is given for the case of changing the placement position of the SRAF 21 or the like as the changing process of the SRAF 21 when the SRAF 21 is not placed at an appropriate position; however, it is applicable that the product mask pattern (lithography target LT1) or the design is corrected.

In this manner, according to the first embodiment, it is possible to evaluate the SRAF 21 that affects the shape of the evaluation target pattern before the lithography verification. Whereby, it is possible to determine whether the placement position of the SRAF 21 is appropriate in a state after the SRAF placement before the OPC process, so that a verification time of a circuit pattern can be shortened. Therefore, the TAT that is caused due to a significant returning process after the lithography verification can be reduced. Thus, the mask pattern can be completed in a short time.

### Second Embodiment

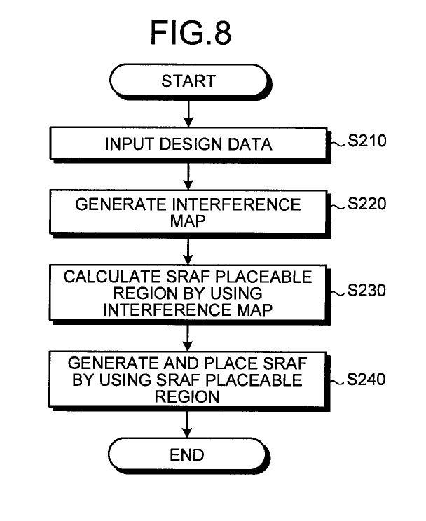

Next, the second embodiment is explained with reference to FIG. 7 and FIG. 8. In the second embodiment, the mask pattern is generated so that the SRAF 21 is placed at an appropriate position by using the interference map. Specifically, the placement appropriateness is calculated by using the interference map and the score when the SRAF 21 is placed is calculated by using the placement appropriateness. Then, the SRAF 21 is placed at an appropriate position by using a calculation result of the score.

FIG. 7 is a diagram illustrating a configuration of a pattern generating apparatus according to the second embodiment. A pattern generating apparatus 4 is an apparatus, such as a computer, that generates the mask pattern in which the SRAF 21 is placed by using the interference map. The pattern generating apparatus 4 includes an input unit 41, an interference-map generating unit 42, a score calculating unit 43, an SRAF generating unit 44, and an output unit 45.

The input unit 41 inputs the lithography target LT1 (SRAF pre-placement data) that is the product mask pattern before the SRAF 21 is placed. The interference-map generating unit 42 generates the interference map on the lithography target LT1 by using the lithography target LT1 input to the input unit 41 in the similar manner to the interference-map generating unit 12 in the first embodiment. The interference-map generating unit 42 sends the generated interference map to the score calculating unit 43.

The score calculating unit 43 calculates a region, whose score becomes a predetermined value or more when the SRAF 21 is placed, as an SRAF placeable region by using the interference map generated by the interference-map generating unit 42. The SRAF placeable region is a region in which the SRAF 21 of a predetermined size can be placed. The score calculating unit 43 sends the calculated SRAF placeable region to the SRAF generating unit 44.

The SRAF generating unit 44 generates the SRAF 21 by using the SRAF placeable region calculated by the score calculating unit 43 and places the SRAF 21 on the lithography target LT1. The SRAF 21 to be placed can be placed by the rule-based SRAF placing method or the model-based SRAF placing method. The output unit 45 outputs the mask pattern data generated by the SRAF generating unit 44 as the SRAF post-placement layout.

Next, a generating process procedure of the SRAF 21 is explained. FIG. 8 is a flowchart illustrating the generating process procedure of the SRAF. The lithography target LT1 is input to the input unit 41 of the pattern generating apparatus 4 as the SRAF pre-placement data before the SRAF 21 is placed (Step S210).

The interference-map generating unit 42 generates the interference map on the lithography target LT1 by using the lithography target LT1 input to the input unit 41 (Step S220). The interference-map generating unit 42 sends the generated interference map to the score calculating unit 43.

The score calculating unit 43 calculates the SRAF placeable region by using the interference map generated by the interference-map generating unit 42 (Step S230). In the case of including a large region with high placement appropriateness on the interference map, it becomes the SRAF placeable region, and in the case of including a large region with low placement appropriateness is large on the interference map, it does not become the SRAF placeable region.

The SRAF generating unit 44 generates the SRAF 21 by using the SRAF placeable region calculated by the input unit 31 and places the SRAF 21 on the lithography target LT1 (Step S240). Thereafter, the output unit 45 outputs the mask pattern data generated by the SRAF generating unit 44 as the SRAF post-placement layout.

In this manner, according to the second embodiment, it becomes possible to evaluate a position of the SRAF 21 that affects the shape of the evaluation target pattern before generating the SRAF 21 by using the interference map. Thus, the SRAF 21 can be placed at an appropriate position in a short TAT. Consequently, it becomes possible to complete the mask pattern in which the SRAF 21 is placed in a short time.

### Third Embodiment

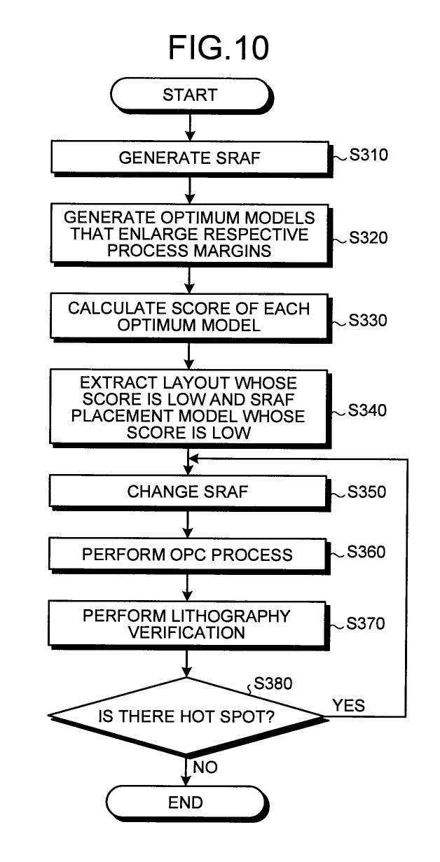

Next, the third embodiment is explained with reference to FIG. 1, FIG. 9A, FIG. 9B, and FIG. 10. In the third embodiment, the score is calculated for each SRAF placement model by using a plurality of types of the SRAF placement models. Then, a layout (SRAF post-placement layout) that causes the hot spot or an insufficient process margin is extracted by comparing the scores.

The pattern evaluating apparatus 1 in the present embodiment has a configuration similar to the pattern evaluating apparatus 1 explained in the first embodiment. The pattern evaluating apparatus 1 in the present embodiment generates the SRAF 21 with respect to the lithography target LT1 in accordance with each of a plurality of types of the SRAF placement rules/SRAF placement models. Specifically, the pattern evaluating apparatus 1 generates the SRAF 21 for each of the SRAF placement rules/SRAF placement models to place it around the lithography target LT1. For example, the interference-map generating unit 12 performs the SRAF placement corresponding to each optical model by using each of an EL maximizing model (image tile maximizing model), a DOF maximizing model, a center-image-intensity maximizing model (penetration-property improving model of a contact hole), and an σ sensitivity maximizing model as the optical model.

Moreover, the interference map is different depending on a layout of the lithography target LT1. Therefore, an optimum placement position of the SRAF 21 is different depending on a layout of the lithography target LT1. In this manner, the optimum placement position of the SRAF 21 indicates various calculation results depending on the SRAF placement rule/SRAF placement model used for generating the interference map and the placement position of the product pattern.

A calculation example of the SRAF placement using a plurality of types of the SRAF placement rules is explained. FIG. 9A and FIG. 9B are diagrams illustrating a result of predicting the optimum SRAF placement position based on a plurality of types of physics models with respect to the same lithography target. FIG. 9A illustrates an interference map (placement appropriateness) a3 calculated by the EL maximizing model and an interference map a4 calculated by the center-image-intensity maximizing model with respect to a first product pattern. FIG. 9B illustrates an interference map b3 calculated by the EL maximizing model and an interference map b4 calculated by the center-image-intensity maximizing model with respect to a second product pattern.

The EL maximizing model is the physics model that maximizes a pattern boundary image slope of the product pattern, and the center-image-intensity maximizing model is the physics model that maximizes the center image intensity of the product pattern.

As shown in FIG. 9A, an SRAF post-placement pattern a2 in which the SRAFs 21 are placed on a first product pattern a1 is generated. Then, the interference map a3 is generated by the EL maximizing model and the interference map a4 is generated by the center-image-intensity maximizing model on the SRAF post-placement pattern a2.

As shown in FIG. 9B, an SRAF post-placement pattern b2 in which the SRAFs 21 are placed on a second product pattern b1 is generated. Then, the interference map b3 is generated by the EL maximizing model and the interference map b4 is generated by the center-image-intensity maximizing model on the SRAF post-placement pattern b2.

As shown in FIG. 9A and FIG. 9B, it is found that the placement appropriateness matches in many portions, however, a region with difference placement appropriateness also exists, between the interference map a3 generated by the EL maximizing model and the interference map a4 generated by the center-image-intensity maximizing model. In the similar manner, it is found that the placement appropriateness matches in many portions, however, a region with difference placement appropriateness also exists, between the interference map b3 generated by the EL maximizing model and the interference map b4 generated by the center-image-intensity maximizing model.

In the followings, an extracting process of the hot spot is explained by using the interference map a3 generated by the EL maximizing model and the interference map a4 generated by the center-image-intensity maximizing model with respect to the first product pattern a1.

In the region with difference placement appropriateness between the interference map a3 and the interference map a4, the process margin tends to become insufficient with respect to any of processes. Therefore, in the present embodiment, the evaluating unit 14 calculates a difference between the score of the placement appropriateness calculated by using the interference map a3 generated by the EL maximizing model and the score of the placement appropriateness calculated by using the interference map a4 generated by the center-image-intensity maximizing model. Then, a region (layout) in which the difference between the calculated scores is larger than a predetermined value is extracted as a portion at which the hot spot (danger point) occurs because the SRAF placement is not optimum.

It is applicable that the evaluating unit 14 extracts the optimizing model whose score is different from other scores by a predetermined value or more among the scores calculated by using various SRAF placement models (EL maximizing model, center-image-intensity maximizing model, DOF maximizing model, and a sensitivity maximizing model). For example, the evaluating unit 14 calculates a region whose score is different compared with other interference maps, and a difference degree (difference between the scores) in this region. Then, a total value of the difference degree is calculated for each interference map and the SRAF placement model having the difference degree larger than a predetermined value is extracted. When there is the SRAF placement model having the difference degree larger than the predetermined value, it can be said that a process corresponding to this SRAF placement model has a small margin with respect to the process fluctuation.

As described above, it is possible to specify the SRAF placement layout that is highly likely to be the danger point and the type of the process margin that is highly likely to be the danger point before the lithography verification in a state in which only the SRAF placement is performed by comparing the interference maps generated by various SRAF placement models.

Next, a generating process procedure of the mask pattern data is explained. FIG. 10 is a flowchart illustrating the mask-pattern-data generating process procedure according to the third embodiment. In the processes shown in FIG. 10, explanation of the process similar to the process in FIG. 2 and FIG. 3 is omitted.

The generating apparatus of the mask pattern generates the lithography target LT1 that is the product mask pattern by using the design data. Then, the generating apparatus of the mask pattern generates and places the SRAF 21 near the lithography target LT1 and the like (Step S310).

In the present embodiment, optimum models (SRAF placement models) that enlarge respective process margins are generated in advance (Step S320). Specifically, the EL maximizing model, the DOF maximizing model, the image slope maximizing model, and the like are generated and registered in the interference-map generating unit 12 in advance.

The SRAF post-placement layout is input to the input unit 11 of the pattern evaluating apparatus 1. The interference-map generating unit 12 generates the interference map on the SRAF post-placement layout by using the SRAF post-placement layout input to the input unit 11. The interference-map generating unit 12 generates the interference map corresponding to each SRAF placement model by using each SRAF placement model. The interference-map generating unit 12 sends each generated interference map to the score calculating unit 13.

The score calculating unit 13 calculates the placement appropriateness of the SRAF 21 in the mask pattern as the score by using each interference map generated by the interference-map generating unit 12 (Step S330). The score calculating unit 13 sends the calculated score of the SRAF 21 to the evaluating unit 14.

The evaluating unit 14 evaluates whether the SRAF 21 in the SRAF post-placement layout is placed at an appropriate position by using the score of the SRAF 21 calculated by the score calculating unit 13. Specifically, the evaluating unit 14 extracts the SRAF placement model (SRAF placement model whose score is low) whose score is different from the scores calculated by using other optimum maps by a predetermined value or more among the scores calculated by using various SRAF placement models. Whereby, the evaluating unit 14 extracts the type of the process corresponding to the SRAF placement model having the different degree more than a predetermined value as the process whose process margin is insufficient. Moreover, the evaluating unit 14 extracts a layout (SRAF 21 that is not placed at an appropriate position) whose score is lower than a predetermined value (Step S340).

In other words, the evaluating unit 14 determines that the placed SRAF 21 is the hot spot (danger point) if the margin with respect to a predetermined process fluctuation, by which the SRAF 21 is easily affected, is insufficient. Moreover, the evaluating unit 14 determines the SRAF 21 whose score is lower than a predetermined value as the hot spot. Whereby, it becomes possible to extract the hot spot (danger point) that occurs because the SRAF placement is not optimum.

When the placement position of the SRAF 21 placed on the SRAF post-placement layout or the process margin is inappropriate, the pattern changing apparatus 3 changes the SRAF 21 (Step S350).

An SRAF changing method that enlarges the process margin is explained. FIG. 11A to FIG. 11E are diagrams illustrating the interference maps of an isolated hole layout pattern. FIG. 11A to FIG. 11E illustrate the interference maps when the lithography target LT1 is the isolated hole layout pattern. In FIG. 11A to FIG. 11E, regions A4 and A5 are regions that enlarge the process margin and regions A1 and A2 are regions that degrade the process margin.

An interference map 61 shown in FIG. 11A is the interference map (interference map that maximizes the EL) that maximizes an optical image slope at a pattern edge of the lithography target LT1. An interference map 62 shown in FIG. 11B is the interference map (interference map that maximizes the EL when considering only a CD margin in an y direction) that maximizes the optical image slope in the y direction (vertical direction in FIG. 11B) at the pattern edge of the lithography target LT1. An interference map 63 shown in FIG. 11C is the interference map (interference map that maximizes the EL when considering only the CD margin in an x direction) that maximizes the optical image slope in the x direction (horizontal direction in FIG. 11C) at the pattern edge of the lithography target LT1.

An interference map 64 shown in FIG. 11D is the interference map (interference map that maximizes the center image intensity of a hole) that improves the penetration-property of the lithography target LT1 (hole pattern) under the best focus condition. An interference map 65 shown in FIG. 11E is the interference map (interference map that maximizes the center image intensity of a hole) that improves the penetration-property of the lithography target LT1 (hole pattern) under a defocus condition. The process margin corresponding to each of the interference maps 61 to 65 is improved by placing the SRAF 21 in the regions A5 and A4 of the interference maps 61 to 65.

In the present embodiment, after placing the SRAF 21 by any of the methods such as the rule-based SRAF placing method and the model-based SRAF placing method, the appropriateness of the placement position of the SRAF 21 in the SRAF post-placement layout is calculated for each SRAF placement model as the score by using each SRAF placement model used for generating the above interference maps 61 to 65.

Then, when the SRAF post-placement layout whose calculated score is low is determined, the placement position of the SRAF 21, the SRAF placement rule, or the SRAF placement model is changed as the changing process of the SRAF 21. Specifically, revision of the SRAF placing method, a mask layout correction, revision of the design data, or the like is performed so that the score becomes a sufficiently high value with respect to any SRAF placement model. As the revision of the SRAF placing method, for example, revision of the SRAF placement rule is performed in the case of the rule-based SRAF placing method and revision of the SRAF placement model is performed in the case of the model-based SRAF placing method. The pattern changing apparatus 3, for example, corrects the design, the mask layout, or the like to enlarge the insufficient process margin.

Explanation is given for a mask layout correcting (repair) method, a correcting method of the design data, and a revising method of the SRAF placing method. First, an example of the mask layout correcting method is explained. When the combination of the SRAF post-placement layout whose score is low and the interference map is found, the mask layout is corrected by at least one of the methods indicated in the following (a1) and (a2).

(a1) In the SRAF post-placement layout, if the SRAF 21 is placed in an interference map region (regions A1 and A2) that degrades the score, deletion of the SRAF 21 in the region, shifting of the placement position of the SRAF 21 in the region, or deformation of the SRAF 21 in the region is performed.

(a2) In the SRAF post-placement layout, if the SRAF 21 is not placed in an interference map region (regions A4 and A5) that improves the score, insertion of the SRAF 21 into the region, shifting of the placement position of the SRAF 21 so that the SRAF 21 is placed in the region, or deformation of the SRAF 21 so that the SRAF 21 is placed in the region is performed.

Next, an example of the correcting method of the design data is explained. When the combination of the SRAF post-placement layout whose score is low and the interference map is found, the design data itself is corrected by at least one of the methods indicated in the following (b1) and (b2).

(b1) In the SRAF post-placement layout, if a circuit pattern (lithography target LT1) is placed in the interference map region that degrades the score, correction of placing the circuit pattern to a different position, shifting of the placement position of the circuit pattern, or deformation of the circuit pattern is performed.

(b2) In the SRAF post-placement layout, if a circuit pattern is not placed in the interference map region that improves the score, correction of the circuit pattern so that the circuit pattern is placed in the region, or shifting or deformation of the placement position is performed.

Next, an example of the revising method of the SRAF placing method is explained. When the score is improved by the above methods of (a1) and (a2), the SRAF placement rule is changed by a method indicated in the following (c1).

(c1) In the SRAF placement rule, the shape of the SRAF placement with respect to the lithography target LT1 is ruled and is added to the SRAF placement rule.

Whereby, the SRAF placement rule can be corrected to the SRAF placement rule whose accuracy is higher than before the new rule is added.

After the changing process of the SRAF 21, the OPC processing apparatus performs the OPC process on the mask pattern in which the SRAF 21 is changed (Step S360). Then, the lithography verifying apparatus performs the lithography verification by using the mask pattern data after the OPC process (Step S370). Then, the lithography verifying apparatus determines whether there is the hot spot in the mask pattern after the OPC process (Step S380).

Whereby, it is possible to clarify extraction of problems (SRAF 21 placed at an inappropriate position and type of an insufficient process margin), which is conventionally clarified for the first time in the lithography verification after the OPC process, in the state after the SRAF placement before the OPC process.

Thereafter, the processes at Step S350 to 5380 are repeated until it is determined that there is no hot spot in the mask pattern after the OPC process. Then, when it determined that there is no hot spot in the mask pattern after the OPC process (No at Step S380), the mask pattern that is determined to have no hot spot is set as the mask pattern for forming the product pattern.

Explanation is given for a difference between a conventional SRAF evaluating method and the SRAF evaluating method in the present embodiment. Conventionally, the SRAF placement model is generated to ensure the process margin of a representative mask layout. Alternatively, the SRAF placement model is generated to ensure a certain specific process margin at a maximum. A lithography designer appropriately determines which physic model (for example, EL maximizing model, DOF maximizing model, and image slope maximizing model) is selected. However, when one process latitude (for example, EL) is maximized, a different process latitude (for example, DOF) is reduced by that amount in some cases.

The process latitude that becomes insufficient is different depending on a layout, and specially, the best SRAF placement model is hard to generate with the design data including many random layouts, which is a problem.

With the model-based SRAF placing method, it is possible to calculate the SRAF placement model that maximizes each of various process margins. It is possible to generate the SRAF placement model that maximizes each process margin with respect to a type of various process fluctuations or the like, such as the SRAF placement model that is resistant to a dose fluctuation, the SRAF placement model that is resistant to a defocus fluctuation, and the SRAF placement model that is resistant to a coherence a fluctuation of a light source.

Therefore, it is possible to extract the SRAF 21 whose placement position is inappropriate and a type of the process fluctuation that is expected that the process margin is insufficient before the OPC process by comparing the placement position of the SRAF 21 and the interference map (score) generated by a plurality of the SRAF placement models for each SRAF placement model aside from the candidate SRAF placement.

The TAT of the process of generating the SRAF 21 is extremely short compared with the OPC process or the lithography verification. In the present embodiment, evaluation of the SRAF 21 is performed by using a plurality of types of the SRAF placement models, so that it is possible to determine the SRAF 21 whose placement position is inappropriate, the insufficient process margin, and the like accurately in a short time.

In the present embodiment, the case is explained in which various SRAF placement models are registered in the interference-map generating unit 12; however, various SRAF placement models can be registered in an external device other than the pattern evaluating apparatus 1. In this case, the interference-map generating unit 12 reads out the SRAF placement model from the external device in which the SRAF placement models are registered and generates the interference map.

Moreover, in the present embodiment, the case is explained in which the SRAF placement model that enlarges each process margin is generated after generating the SRAF 21; however, the SRAF placement model that enlarges each process margin can be generated before generating the SRAF 21.

It is applicable that the lithography verifying apparatus verifies a latitude (which process margin is insufficient) of the process margin when the product pattern is formed with the mask pattern after the OPC process, or the like. The latitude of the process margin is an index that affects a lithography resolution performance of the product pattern, and is the EL (Exposure Latitude), the DOF (Depth of Focus), the MEF (Mask Enhancement Factor), a contrast, or the like.

As above, according to the third embodiment, the interference maps are generated by using a plurality of types of the SRAF placement models to calculate the scores, and evaluation of the SRAF 21 and evaluation of the process margin are performed by comparing the scores, so that the SRAF 21 that affects the shape of the evaluation target pattern can be evaluated before the lithography verification. Therefore, it is possible to determine whether the placement position of the SRAF 21 or the process margin is appropriate in the state after the SRAF placement before the OPC process, so that the TAT that is caused due to a significant returning process after the lithography verification can be reduced. Thus, the mask pattern can be completed in a short time.

Moreover, evaluation of the SRAF 21 is performed by comparing the interference maps generated by a plurality of types of the SRAF placement models, so that verification of the SRAF 21 can be possible even for a layout with high randomness.

### Fourth Embodiment

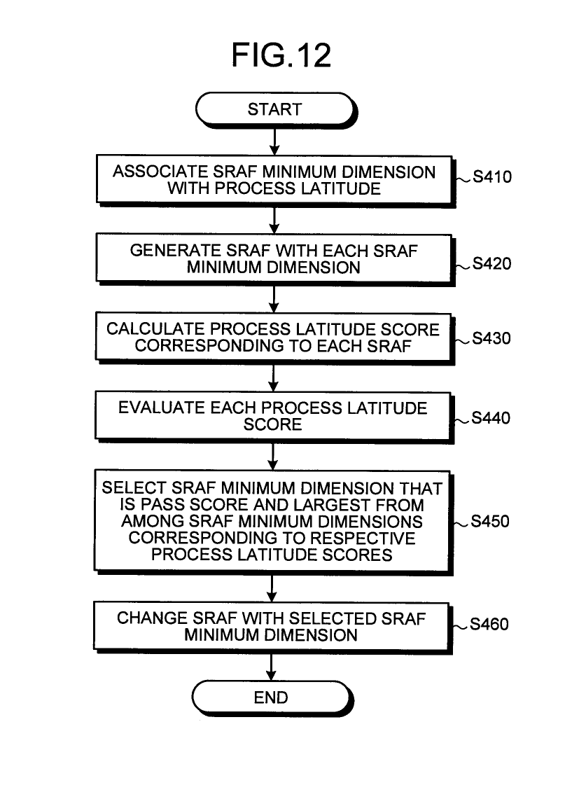

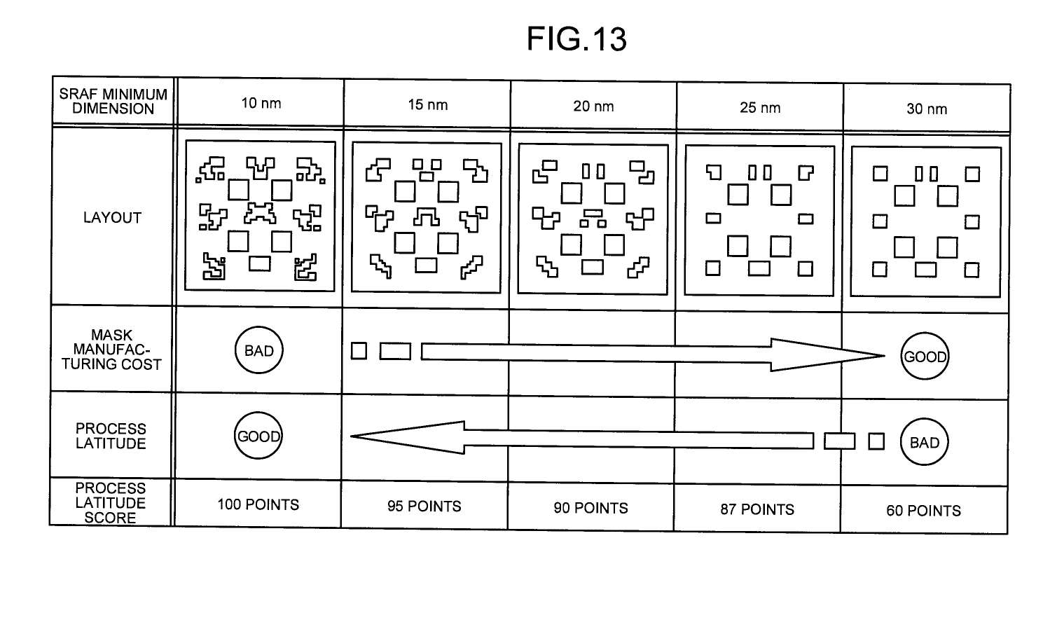

Next, the fourth embodiment is explained with reference to FIG. 12 and FIG. 13. In the fourth embodiment, a minimum dimension (SRAF minimum dimension) of one side of a polygon constituting the SRAF 21 when changing the SRAF 21 is determined based on the process latitude calculated by using the interference map and the SRAF 21 is changed with the determined SRAF minimum dimension.

The pattern evaluating apparatus 1 in the present embodiment has a configuration similar to the pattern evaluating apparatus 1 explained in the first embodiment. The pattern evaluating apparatus 1 in the present embodiment generates the SRAF 21 with respect to the lithography target LT1 in accordance with the SRAF placement rule/SRAF placement model explained in the first embodiment. Moreover, the pattern evaluating apparatus 1 calculates the score (magnitude of the process margin) (hereinafter, process latitude score) for each process latitude by using the interference map. Then, the SRAF 21 is changed with the SRAF minimum dimension in accordance with the process latitude score.

Next, a determining process procedure of the SRAF minimum dimension is explained. FIG. 12 is a flowchart illustrating the determining process procedure of the SRAF minimum dimension. FIG. 13 is a diagram for explaining a correspondence relationship between the process latitude and a mask manufacturing cost. In the processes shown in FIG. 12, explanation of the processes similar to the mask-pattern-data generating process and the determining process of the SRAF 21 explained in FIG. 2, FIG. 3, and FIG. 10 is omitted.

The SRAF minimum dimension (SRAF dimension) and the process latitude are associated in advance (Step S410). The SRAF minimum dimension is a dimension in an MRC and is the minimum dimension (minimum dimension rule) of one side of the SRAF 21 when generating the SRAF 21. As shown in FIG. 13, the mask manufacturing cost becomes low as the SRAF minimum dimension becomes large (described as “good” in FIG. 13), and the mask manufacturing cost becomes high as the SRAF minimum dimension becomes small (described as “bad” in FIG. 13). On the other hand, the process latitude becomes low as the SRAF minimum dimension becomes large (described as “bad” in FIG. 13), and the process latitude becomes high as the SRAF minimum dimension becomes small (described as “good” in FIG. 13).

The SRAF 21 is generated with each SRAF minimum dimension by using the lithography target LT1 and is placed near the lithography target LT1 in advance (Step S420). For example, the SRAF 21 is generated with the SRAF minimum dimension of 10 nm and is placed near the lithography target LT1. Whereby, the SRAF post-placement layout is generated with the SRAF minimum dimension of 10 nm. Moreover, the SRAF 21 generated with the SRAF minimum dimension of 10 nm is converted into the SRAF minimum dimensions of 15 nm, 20 nm, 25 nm, and 30 nm on the SRAF post-placement layout, so that the SRAF post-placement layouts can be generated with the SRAF minimum dimensions of 15 nm, 20 nm, 25 nm, and 30 nm.

The SRAF post-placement layouts generated with the SRAF minimum dimensions of 10 nm to 30 nm are input to the input unit 11 of the pattern evaluating apparatus 1. The interference-map generating unit 12 generates the interference maps on the SRAF post-placement layouts by using the lithography target LT1 input to the input unit 11. In the similar manner to the third embodiment, the interference-map generating unit 12 generates respective interference maps by using various SRAF placement models. The interference-map generating unit 12 sends each of the generated interference maps to the score calculating unit 13.

The score calculating unit 13 calculates the placement appropriateness of all of the SRAFs 21 in the SRAF post-placement layout as the score (total value) by using each interference map generated by the interference-map generating unit 12. The score calculating unit 13 in the present embodiment calculates the process latitude score as the score of the placement appropriateness. Specifically, the score calculating unit 13 calculates the total value of the scores corresponding to the placement appropriateness in the SRAF post-placement layout for each process (for each SRAF placement model), and calculates an average between the processes of this calculation result as the process latitude score corresponding to each SRAF 21 (each SRAF minimum dimension) (Step S430). The score calculating unit 13 sends the process latitude score with each calculated SRAF minimum dimension to the evaluating unit 14.

The evaluating unit 14 evaluates the process latitude score calculated by the score calculating unit 13 (Step S440). Specifically, the evaluating unit 14 determines the process latitude score indicating a predetermined value or more as a pass score, and determines the process latitude score indicating less than the predetermined value as a failure score, among the process latitude scores. FIG. 13 illustrates that the process latitude scores corresponding to the SRAF minimum dimensions of 10 nm, 15 nm, 20 nm, 25 nm, and 30 nm are 100 points, 95 points, 90 points, 87 points, and 60 points, respectively.

Moreover, the evaluating unit 14 selects the SRAF minimum dimension that is the pass score and is the largest from among the SRAF minimum dimensions corresponding to the respective process latitude scores (Step S450). Specifically, the allowable SRAF minimum dimensions are extracted based on the process latitude scores and the maximum SRAF minimum dimension is selected from among the extracted SRAF minimum dimensions.

For example, in the case of the process latitude scores shown in FIG. 13, if the pass score is 80 points, the SRAF minimum dimensions of 10 nm, 15 nm, 20 nm, and 25 nm are the pass score. Then, 25 nm indicating the maximum SRAF minimum dimension among the SRAF minimum dimensions indicating this pass score is selected. Thereafter, the pattern changing apparatus 3 changes the SRAF 21 with the selected SRAF minimum dimension (Step S460). The pattern changing apparatus 3 can change the placement position of the SRAF 21 of the SRAF post-placement layout by the pattern changing unit 34.

In the present embodiment, the case is explained in which the pattern evaluating apparatus 1 generates the SRAF 21 by using various SRAF placement models; however, the pattern evaluating apparatus 1 can generate the SRAF 21 by using a predetermined SRAF placement model as explained in the first embodiment.

As above, according to the fourth embodiment, the process latitude score is calculated by using the interference map and the SRAF minimum dimension is changed with the SRAF minimum dimension corresponding to the calculated process latitude score, so that the SRAF 21 can be changed with an appropriate SRAF minimum dimension before the lithography verification.

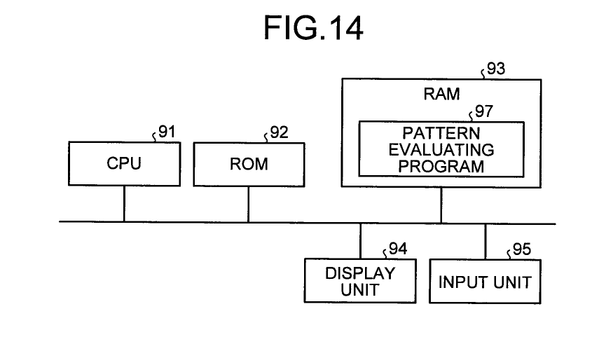

FIG. 14 is a diagram illustrating a hardware configuration of the pattern evaluating apparatus. The pattern evaluating apparatus 1 is an apparatus that performs evaluation of the SRAF post-placement layout of a photomask and includes a CPU (Central Processing Unit) 91, a ROM (Read Only Memory) 92, a RAM (Random Access Memory) 93, a display unit 94, and an input unit 95. In the pattern evaluating apparatus 1, the CPU 91, the ROM 92, the RAM 93, the display unit 94, and the input unit 95 are connected via a bus line.

The CPU 91 executes evaluation of the SRAF post-placement layout by using a pattern evaluation program 97 that is a computer program. The display unit 94 is a display device such as a liquid crystal monitor, and displays the lithography target LT1, the SRAF post-placement layout, the interference map, the mask layout, and the like based on an instruction from the CPU 91. The input unit 95 includes a mouse and a keyboard, and inputs instruction information (such as parameter necessary for pattern evaluation) that is externally input by a user. The instruction information input to the input unit 95 is sent to the CPU 91.

The pattern evaluation program 97 is stored in the ROM 92 and is loaded in the RAM 93 via the bus line. The CPU 91 executes the pattern evaluation program 97 loaded in the RAM 93. Specifically, in the pattern evaluating apparatus 1, the CPU 91 reads out the pattern evaluation program 97 from the ROM 92, loads it in a program storage area in the RAM 93, and executes various processes, in accordance with the input of an instruction by a user from the input unit 95. The CPU 91 temporarily stores various data generated in the various processes in a data storage area formed in the RAM 93.

The pattern evaluation program 97 executed in the pattern evaluating apparatus 1 has a module configuration including the above respective units (the interference-map generating unit 12, the score calculating unit 13, and the evaluating unit 14), and the above each unit is loaded in a main storage device, so that the interference-map generating unit 12, the score calculating unit 13, and the evaluating unit 14 are generated on the main storage device.

The hardware configuration of the pattern evaluating apparatus 1 is explained in FIG. 14, and the pattern changing apparatus 3 and the pattern generating apparatus 4 have the similar hardware configurations. The pattern changing apparatus 3 includes a computer program (pattern changing program) that executes the pattern changing instead of the pattern evaluation program 97. The pattern generating apparatus 4 includes a computer program (pattern generating program) that executes the pattern generation instead of the pattern evaluation program 97.

The pattern changing program executed by the pattern changing apparatus 3 has a module configuration including the above each unit (the SRAF changing unit 32), and the above each unit is loaded in a main storage device, so that the SRAF changing unit 32 is generated on the main storage device.

The pattern generating program executed by the pattern generating apparatus 4 has a module configuration including the above respective units (the interference-map generating unit 42, the score calculating unit 43, and the SRAF generating unit 44), and the above each unit is loaded in a main storage device, so that the interference-map generating unit 42, the score calculating unit 43, and the SRAF generating unit 44 are generated on the main storage device.

While certain embodiments have been described, these embodiments have been presented by way of example only, and are not intended to limit the scope of the inventions. Indeed, the novel methods and computer program products described herein may be embodied in a variety of other forms; furthermore, various omissions, substitutions and changes in the form of the methods and computer program products described herein may be made without departing from the sprit of the inventions. The accompanying claims and their equivalents are intended to cover such forms or modifications as would fall within the scope and spirit of the inventions.

What is claimed is:

1. A method of evaluating a pattern comprising:
generating a proximity pattern that affects a resolution performance of a circuit pattern when forming the circuit pattern on a substrate, around a lithography target pattern that is set based on design data corresponding to the circuit pattern to be formed on the substrate;
generating distribution information on a distribution of an influence degree to the resolution performance of the circuit pattern when a predetermined proximity pattern is placed around the lithography target pattern by using the lithography target pattern;
calculating the influence degree to the resolution performance of the circuit pattern by the proximity pattern as a score by comparing the distribution information with the proximity pattern; and
evaluating whether the proximity pattern is placed at an appropriate position in accordance with the circuit pattern based on the score.

2. The method according to claim 1, wherein
the generating the distribution information includes generating the distribution information on each of pattern placement models by using a pattern placement model of each index that places the proximity pattern so that each process margin is capable of being ensured for each process margin with a different index,
the calculating the score includes calculating the score of each of the pattern placement models by using the distribution information on each of the pattern placement models and the proximity pattern, and
the evaluating includes performing evaluation of whether the proximity pattern is placed at an appropriate position in accordance with a shape of the circuit pattern or evaluation of whether a process margin becomes insufficient when the proximity pattern is placed, based on the score of each of the pattern placement models.

3. The method according to claim 2, wherein
the evaluating includes
comparing scores of the pattern placement models, and
performing evaluation of whether the proximity pattern is placed at an appropriate position in accordance with the shape of the circuit pattern or evaluation of whether the process margin becomes insufficient when the proximity pattern is placed, based on a comparison result.

4. The method according to claim 2, wherein the index is any of an Exposure Latitude, a Depth of Focus, a Mask Enhancement Factor with respect to a dimension fluctuation of a mask, and a σ sensitivity of a light source used for exposure.

5. The method according to claim 1, wherein the proximity pattern is an assist pattern that is not resolved as the circuit pattern.

6. The method according to claim 1, wherein the evaluating is performed before performing an optical proximity correction for generating mask layout data of the circuit pattern.

7. A method of generating a pattern comprising:
generating distribution information on a distribution of an influence degree to a resolution performance of a circuit pattern when the circuit pattern is formed on a substrate by placing a predetermined pattern around a lithography target pattern that is set based on design data corresponding to the circuit pattern to be formed on the substrate, by using the lithography target pattern;
calculating the influence degree to the resolution performance of the circuit pattern by the proximity pattern as a score by comparing the proximity pattern that affects the resolution performance of the circuit pattern when forming the circuit pattern on the substrate with the distribution information; and
placing the proximity pattern near the circuit pattern so that the proximity pattern is placed at an appropriate position in accordance with a shape of the circuit pattern based on the score.

8. The method according to claim 7, further comprising:
determining a minimum dimension of a length of one side of the proximity pattern to be placed near the circuit pattern based on the score that estimates the influence degree to the resolution performance when forming the circuit pattern on the substrate; and
placing the proximity pattern with determined minimum dimension near the circuit pattern.

9. The method according to claim 8, further comprising:
calculating the score when the proximity pattern is generated in accordance with a minimum dimension rule of the proximity pattern used when generating the proximity pattern, for each minimum dimension rule;
extracting an allowed minimum dimension rule based on the score; and
selecting a maximum minimum dimension rule from among extracted minimum dimension rules and generating the proximity pattern.

10. The method according to claim 7, wherein
the generating the distribution information includes generating the distribution information on each of pattern placement models by using a pattern placement model of each index that places the proximity pattern so that each process margin is capable of being ensured for each process margin with a different index,
the calculating the score includes calculating the score of each of the pattern placement models by using the distribution information on each of the pattern placement models and the proximity pattern, and
the placing the proximity pattern near the circuit pattern includes placing the proximity pattern near the circuit pattern so that the proximity pattern is placed at an appropriate position in accordance with the shape of the circuit pattern based on the score of each of the pattern placement models.

11. The method according to claim 10, wherein
the placing the proximity pattern near the circuit pattern includes
comparing scores of the pattern placement models, and
placing the proximity pattern near the circuit pattern so that the proximity pattern is placed at an appropriate position in accordance with the shape of the circuit pattern, based on a comparison result.

12. The method according to claim 10, wherein the index is any of an Exposure Latitude, a Depth of Focus, a Mask Enhancement Factor with respect to a dimension fluctuation of a mask, and a σ sensitivity of a light source used for exposure.

13. The method according to claim 7, wherein the proximity pattern is an assist pattern that is not resolved as the circuit pattern.

14. A computer program product executable by a computer and having a computer readable recording medium including a plurality of instructions, wherein the instructions, when executed by the computer, cause the computer to perform:
generating a proximity pattern that affects a resolution performance of a circuit pattern when forming the circuit pattern on a substrate, around a lithography target pattern that is set based on design data corresponding to the circuit pattern to be formed on the substrate;
generating distribution information on a distribution of an influence degree to the resolution performance of the circuit pattern when a predetermined pattern is placed around the lithography target pattern by using the lithography target pattern; and
calculating the influence degree to the resolution performance of the circuit pattern by the proximity pattern as a score by comparing the distribution information with the proximity pattern.

15. The computer program product according to claim 14, wherein the instructions cause the computer to further perform placing the proximity pattern near the circuit pattern so that the proximity pattern is placed at an appropriate position in accordance with a shape of the circuit pattern based on the score.

16. The computer program product according to claim 15, wherein
the generating the distribution information includes generating the distribution information on each of pattern placement models by using a pattern placement model of each index that places the proximity pattern so that each process margin is capable of being ensured for each process margin with a different index,
the calculating the score includes calculating the score of each of the pattern placement models by using the distribution information on each of the pattern placement models and the proximity pattern, and
the evaluating includes performing evaluation of whether the proximity pattern is placed at an appropriate position in accordance with the shape of the circuit pattern or evaluation of whether a process margin becomes insufficient, based on the score of each of the pattern placement models.

17. The computer program product according to claim 16, wherein
the evaluating includes
comparing scores of the pattern placement models, and
performing evaluation of whether the proximity pattern is placed at an appropriate position in accordance with the shape of the circuit pattern or evaluation of whether the process margin becomes insufficient when the proximity pattern is placed, based on a comparison result.

18. The computer program product according to claim 16, wherein the index is any of an Exposure Latitude, a Depth of Focus, a Mask Enhancement Factor with respect to a dimension fluctuation of a mask, and a σ sensitivity of a light source used for exposure.

19. The computer program product according to claim 14, wherein the proximity pattern is an assist pattern that is not resolved as the circuit pattern.

20. The computer program product according to claim 16, wherein the evaluating is performed before performing an optical proximity correction for generating mask layout data of the circuit pattern.
